(19) United States
(12) Patent Application Publication
(10) Pub. No.: US 2002/0161708 A1
(43) Pub. Date: Oct. 31, 2002

(54) Method and apparatus for performing a cashless payment transaction

(76) Inventor: Gero Offer, Gartingen (DE)

Correspondence Address: BELL, BOYD & LLOYD, LLC, P. O. BOX 1135, CHICAGO, IL, 60690-1135, US

(21) Appl. No.: 10/061,698

(22) Filed: Jan. 31, 2002

(30) Foreign Application Priority Data
Feb. 1, 2001 (DE) 101 045 41.7

(51) Int. Cl. G06F 17/60

(52) U.S. Cl. 705/44

(57) ABSTRACT

A method for performing a cashless payment transaction using a mobile terminal having an image output device, a trader station having an image reading device and a central station which is connected to the trader station via a data network, where the image output device of the mobile terminal displays graphically coded output information suitable for authenticating a user, the output information being read into the trader station by the image reading device and being authenticated by the central station.

### BACKGROUND OF THE INVENTION

In recent years, cashless payment transactions have gained increasing acceptance. The reasons for this can be seen as being that purchasers then have no need to carry large sums of money on them in order to make purchases. Significant advantages can be seen as being that the risk of theft is reduced and the threshold for spontaneous purchases is lowered. There is also an advantage for the trader, since he/she does not have to handle large sums of cash.

In the past, credit cards were introduced to allow a cardholder to use a credit card allocated to him/her and his/her signature, or else just a credit card number associated with the credit card, to make a cashless payment. However, the risk of misuse is relatively high in this case, since credit cards can be used without authorization in the event of theft and with a forged signature. The transaction charges arising in connection with the credit card are also often very high.

As an alternative to the credit card, smart cards having an integrated processor memory unit have been developed. Smart cards use encryption technology, which allows sums of money to be stored on the card such that the card can be loaded only through authorized providers. To pay a sum on a trader's premises, a PIN is provided which is checked directly by the smart card during the payment. However, this type of payment requires a dense network of loading stations associated with the banks in order to cross the public's acceptance threshold. Furthermore, the traders need to provide appropriate smart card reading stations.

Hence, cashless payments using a mobile terminal, for example a mobile radio terminal or a personal digital assistant (PDA) in conjunction with a mobile radio terminal, are becoming increasingly important. Since mobile terminals, in particular mobile radio telephones, have become so widespread that they are carried by virtually everyone, they ought to become the personal terminal for payment transactions and, therefore, ought to replace credit cards and smart cards in the medium term.

A method for cashless payment using a mobile radio terminal involves a sum of money for goods purchased by a purchaser being read in on a trader station. In this context, the trader station can be connected to the trader's till system; for example, directly. Alternatively, the sum of money also can be entered directly using an input device on the trader station. This sum is transmitted, together with an identifier for the trader station, via a data network to a central station, where the data are buffer-stored. The customer uses the mobile radio terminal to send the trader station's identifier to the central station, which then compares the identifier with the identifier of the stored data and then transmits the appropriate sum of money to the mobile radio terminal.

The mobile radio terminal requests confirmation of the payment and transmits it to the central station. In this context, the confirmation usually takes the form that the sum to be paid is displayed on a display on the mobile radio terminal and, if the sum displayed is correct, the user uses an entry (presses the OK key) to send his/her confirmation to the central station. The central station then transmits an appropriate debit to an account-managing facility; for example, a bank with which the customer has an account. Hence, a mobile radio terminal, a trader station and a central station are required for this method. In this case, the central station is connected to the mobile radio terminal and to the trader station via telecommunication and/or data links.

This method of cashless payment can be carried out on a mobile basis at a wide variety of places, amongst other things at vending machines (e.g., drinks, sweets or cigarette machines) or in taxis. Unlike when credit cards are used, the merely temporary mobile radio telephone connection and the entry of confirmation during this time allow for it to be virtually impossible in practice for the trader to use data interchanged during the connection without authorization. As such, there is no possibility of misuse by traders for possible later transactions. In addition, the involvement of the central station allows a payment to be made where security-related data of the purchaser, such as the identifier, are not disclosed to the trader. This ensures secure and anonymous payment by the customer.

The widespread use of mobile radio terminals allows for this method of cashless payment to be used without significant further investment. This method is also tremendously suitable for transactions involving very small sums. It is also independent of the type of mobile radio agreement, wherein users with a prepaid account can also make cashless payments with a trader. It also can be regarded as advantageous that this method can be used not only for payment in real shops or department stores but also in “virtual shops”; for example, in a virtual Internet shop.

However, a drawback is that the steps for identifying and authenticating the user are performed by calling back the mobile radio terminal with a request for entry of a PIN stipulated in advance by the user. These steps are time-consuming and require patience from the trader, from the user and from the other customers waiting behind the user. In addition, this method requires two telecommunication and/or data links, which means that it is relatively costly. It is also found to be a drawback that this method fails completely in the event of a fault in a mobile radio system (GSM, GPRS, UMTS, etc). These faults can be caused, by way of example, by a temporarily overloaded mobile radio network or a radio hole.

Another method, one which is not dependent on the current existence of a mobile radio link, uses coding introduced on the mobile radio terminal, for example a bar code, to identify/authenticate the user. However, this method is also found to be disadvantageous, since it can (also occasionally) quickly and efficiently be used for dishonest purposes in the event of the mobile radio terminal being lost.

The present invention is, therefore, directed toward providing a method for simple, secure and transparent cashless payment for goods and/or services using a mobile terminal, and also a trader station and a central station for carrying out the method.

### SUMMARY OF THE INVENTION

In accordance with the teachings of the present invention, the image output device of the mobile terminal displays graphically coded output information suitable for authenticating the user, the output information being read into the trader station by an image reading device and being authenticated by the central station. To be able to pay for goods and/or services using a prepaid or postpaid account, it is necessary to ensure that authentication information associated with the user, for example including a PIN number and/or an identification number and/or telephone number stored on the SIM card in the mobile terminal, is transmitted securely and transparently to a bill issuer (central station). There, the authentication information is checked by comparing it with user information stored there.

If the result of authentication is positive, the payment transaction is approved and a payment guarantee is granted, in a similar manner to in the case of the customary procedures for credit cards and EC cards. The graphically coded output information is used to transmit its inherent authentication information from the trader station to the central station quickly and securely via a data line. Authentication therefore takes place without a mobile radio link between the mobile terminal and the central station.

In one preferred embodiment, the coded output information is produced from a PIN number and/or from an identification number or telephone number (MSISDN) stored on the SIM card in the mobile terminal. This results in clear authentication of the user. Particularly, the entry of the PIN number makes it possible to prevent misuse of the method when the mobile terminal has been lost. In this context, for the sake of simplicity, this PIN number can be the same as the SIM PIN of the mobile radio terminal, but it proves to be even more secure to arrange an independent PIN. To achieve the greatest possible security, the coded output information can be produced from all three of the aforementioned numbers.

In one preferred embodiment, the method includes the following substeps:

a) an electronic credit is set and stored in a credit memory in the central station,

b) a coding algorithm is triggered in an encryption device in the mobile terminal in order to produce a digital code in response to the PIN number and/or the identification number and/or the telephone number,

c) a conversion device is used to convert the digital code into the graphically coded output information, and this is displayed on the image output device of the mobile terminal,

d) the image reading device in the trader station is used to read the graphically coded output information, and this is converted into the digital code,

e) the digital code is transmitted to the central station together with a sum to be paid,

f) an inverse coding algorithm is triggered in a decryption device in the central station in order to decrypt the digital code into user information, and this is compared with authentication information stored in a user memory,

g) a confirmation signal is triggered if authentication has occurred, and a decimation device performs a decimation function for the electronic credit by the sum received, and the credit balance is stored in the credit memory. These steps require no further investment in further components on the part of the customer and the trader, but rather can be implemented purely in software.

Preferably, the method is carried out such that, after method step g), a further substep g1) includes a confirmation function being triggered after the decimation function has been performed, and the confirmation function being transmitted to the trader station. Thus, the customer and the trader receive confirmation when a payment has been made.

In another preferred embodiment, the coded output information is shown on the image output device of the mobile terminal in the form of a bar code. Bar codes have been implemented extensively in trading as a fast and simple price input system and have, thus, ousted price tags, which are laborious to attach.

Preferably, the image reading device is in the form of a bar code scanner. As such, the trader does not need to make any further investment in other equipment in order to carry out the method, since bar code scanners can be found in virtually any shop.

In one preferred embodiment, the coded output information is shown on the image output device in a stipulated time interval, preferably 2 to 5 seconds. Since this time merely allows the bar code to be scanned by the bar code scanner, any misuse using the display is thus prevented.

Preferably, the mobile terminal is in the form of a mobile radio terminal or in the form of a PDA. It is found to be advantageous in the case of mobile radio terminals to show only the traditional bar code, on the basis of the size and reproduction quality of the display on a mobile radio terminal. Bar codes allow any desired strings of ASCII characters or binary data to be coded. These bar codes are one-dimensional, since the information is coded only in the direction of reading.

Since the displays on PDAs have a greater area and are also often richer in contrast, PDAs afford the opportunity to show two-dimensional (2D) bar codes.

Two-dimensional bar codes can code information in two directions. The most widespread 2D bar codes are the PDF 417 (Portable Data File) and Data Matrix codes. Two-dimensional bar codes achieve much higher densities of information than traditional bar codes. The PDF 417 code can be used to achieve, depending on the output quality and the degree of error correction, a character density of up to 100 bits per cm² (binary). Data Matrix theoretically can be used to achieve even higher character densities. Error correction methods make it possible for the code still to be read when up to 40% of the surface is dirty or covered.

Preferably, the coded image information is produced using an asymmetric encryption protocol; in particular, an RSA protocol (Riverest, Shamir, Adleman protocol) or an ECC protocol (Elliptic Curve Cryptography). These protocols each use two keys for encryption and decryption, with the key for encryption being able to be known generally (it is useless for decryption, however). These methods have the advantage that the key need no longer be exchanged for decoding, which has been found to be a weakness in earlier cryptographic methods; for example, DES (Data Encryption Standard).

Additional features and advantages of the present invention are described in, and will be apparent from, the following Detailed Description of the Invention and the Figures.

### BRIEF DESCRIPTION OF THE FIGURES

FIG. 1 shows a schematic illustration of a system for cashless payment using a mobile radio terminal, based on the prior art.

FIG. 2 shows a schematic illustration of a mobile radio terminal.

FIG. 3 shows a schematic illustration of a central station.

FIG. 4 shows a schematic illustration of the mobile radio terminal with a bar code displayed.

FIG. 5 shows a PDA with a two-dimensional bar code displayed.

### DETAILED DESCRIPTION OF THE INVENTION

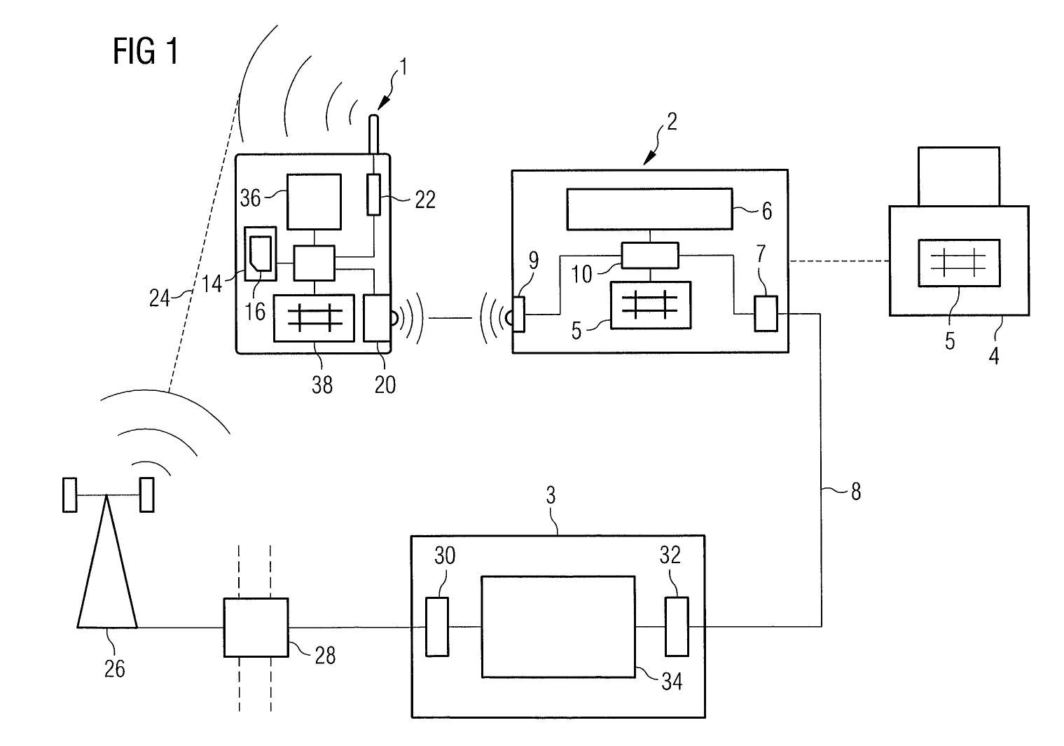

FIG. 1 shows a schematic illustration of a system for cashless payment using a mobile radio terminal 1. Also shown are a trader station 2 and a central station 3 which are temporarily connected to one another. The central station 3 is connected to the mobile radio terminal 1 via a mobile radio link and to the trader station 2 via a data link. The three devices, mobile radio terminal 1, trader station 2 and central station 3, each have identifying identifiers which, by way of example, are the telephone numbers of the mobile radio terminal 1, of the trader station 2 and of the central station 3. Instead of the telephone numbers, other identifiers, for example IP addresses, also can be used.

If a purchaser wants to pay for goods and/or a service with an electronic credit, the sum for the goods and/or service is first read into the trader station 2. This is done, by way of example, by first entering the sum into an electronic till system 4 connected to the trader station 2. The sum is then transmitted to the trader station 2. Preferably, the sum can also be read into the trader station 2 directly using a trader station input device 5; for example, a keypad or a scanner. The sum is displayed on a first output device 6.

The sum is then transferred to the central station 3 via a first transceiver 7. In addition to the sum, an identifier for the mobile radio terminal 1 is transmitted to the central station 3, as described further below. Preferably, this information is transmitted via a data link 8. The data link 8 also can be any suitable type of telecommunication link.

The trader station 2 also has a second transceiver 9 for receiving the identifier of the mobile radio terminal 1. This may be an infrared interface or a Bluetooth module. The first and second transceivers 7, 9 and the input and output devices 5, 6 are connected to a first processor device 10.

The mobile radio terminal 1 has an inherently known SIM card 16, which needs to be activated by entering a PIN. The SIM card is located in a SIM card reader/writer 14. This SIM card 16 is used to generate the identifier of the mobile radio terminal 1. In addition, for interchanging data, the mobile radio terminal 1 has a third transceiver 20 which, by way of example, is again formed by the aforementioned infrared interface or the Bluetooth module.

In this context, the interchanged data are the identifier of the mobile radio terminal 1. Besides this it is also possible to transmit the identifier of the trader station 2 to the mobile radio terminal 1, and/or information about the sum of money to be paid. In addition, the mobile radio terminal 1 uses a fourth transceiver 22 to transmit its identifier to a GSM base station 26 via an air interface 24. The identifier is then transmitted to the central station 3 via a switching station 28; e.g., upon request by the central station.

The central station 3 has a fifth transceiver 30 for setting up a connection to the switching station 28, and a sixth transceiver 32 for setting up a connection to the trader station 2. The central station 3 also has a logging device 34 which is connected to the transceivers 30, 32 and is explained in more detail in FIG. 3.

The logging device 34 transmits the sum received from the trader station 2 back to the mobile radio terminal 1 via the air interface 24. A second output device 36 on the mobile radio terminal 1 displays this sum. The user is then requested to transmit confirmation information to the central station 3 if the sum displayed is correct. This can be done, by way of example, by pressing a particular key on a second input device 38 on the mobile radio terminal 1. When the confirmation information is received at the central station 3, the sum is then debited from an account of the user.

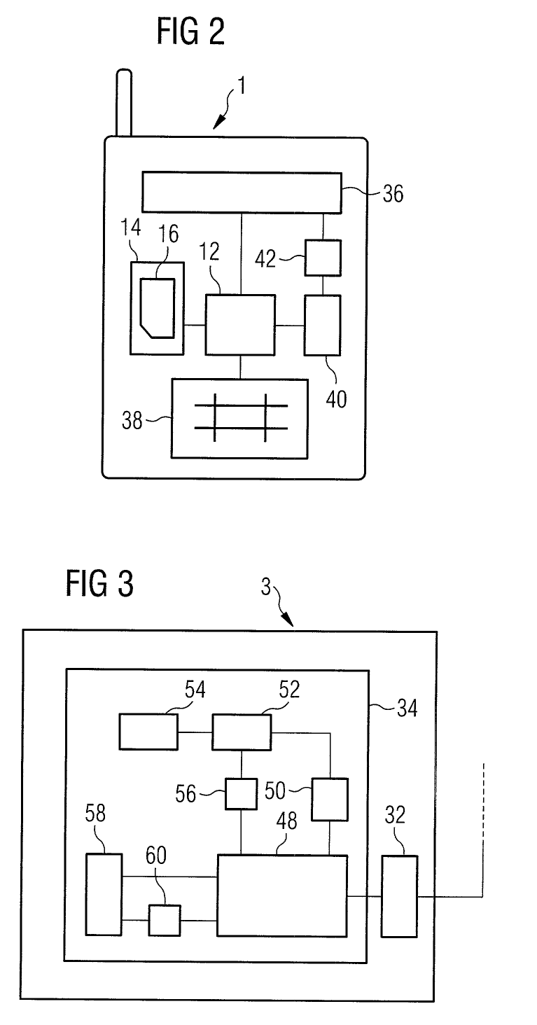

FIG. 2 shows a schematic illustration of the design of the mobile radio terminal 1 in more detail. The terminal contains the terminal based on the prior art, which is shown in FIG. 1, the second processor device 12, to which the second input device 38 is connected, and the SIM reader/writer 14 with the SIM card 16 it contains. The second processor device 12 additionally has an encryption device 40 connected to it which is used to code a digital code in response to a PIN number and/or to the identification number and/or telephone number stored on the SIM card.

The encryption device 40 preferably encrypts all three of the aforementioned numbers using an asymmetric encryption protocol; in particular, an RSA protocol or ECC protocol. The encrypted output information is transmitted to a conversion device 42 which converts this digital code into digital output information. This graphically portrayable digital output information is shown on the second output device 36. The digital output information can be shown in the form of a bar code.

FIG. 3 shows a schematic illustration of the design of the central station 3 in more detail. The central station's logging device 34 contains a third processor device 48, which is connected to a decryption device 50 which uses a decryption protocol to decrypt the digital code received by the sixth transceiver 32 and sent to the third processor device 48.

In this case, the decryption protocol is compatible with the encryption protocol used in the encryption device 40 in the mobile radio terminal 1. The output of the decryption device 50 produces user information which can be used to infer the PIN number and/or the identification number and/or the telephone number of the user. The user information is supplied to a comparator device 52. This device simultaneously has access to a user memory 54 storing authentication information for the user. The authentication information makes it possible to infer the aforementioned three numbers, which actually have been arranged in advance. The comparator device 52 then compares the authentication information stored in the user memory 54 with the user information decoded by the decryption device 50 and, if there is a match, sends an appropriate signal to a confirmation device 56.

This device sends a preferably coded confirmation signal to the third processor device 48. Following receipt of the confirmation signal, the third processor device 48 reads the respective credit of the user from a credit memory 58 associated with the user and checks whether the user's credit is enough to cover the sum which likewise has been transmitted by the trader station 2. If the credit account has sufficient cover, the credit is decimated by the sum using a decimation device 60, which is likewise connected to the third processor device 48, and the credit balance is then stored in the credit memory 58 connected to the decimation device 60.

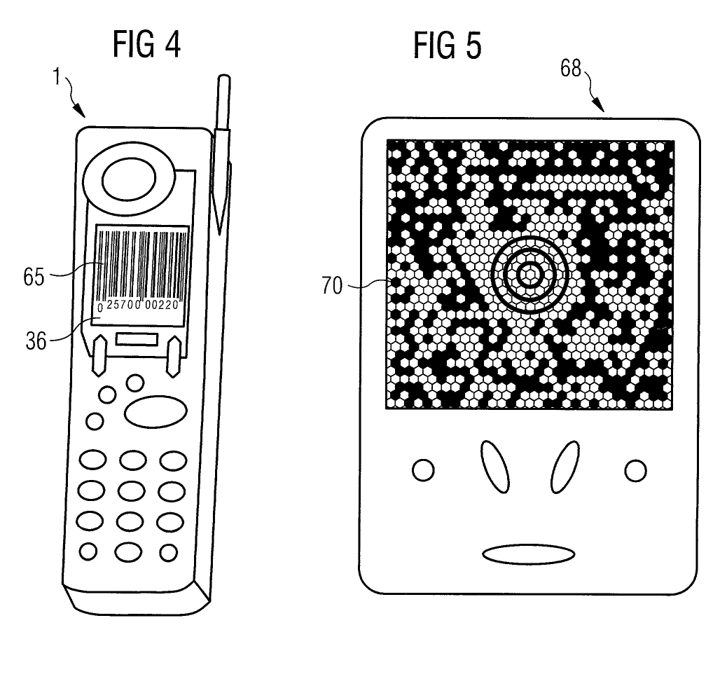

FIG. 4 shows an external view of the mobile radio terminal 1 with a bar code 65 shown on the second output device 36. The bar code has been used for decades in order to identify retail items, transport items, medicaments, library books, etc.

FIG. 5 shows an external view of a PDA 68 with a two-dimensional bar code 70 shown on the output device (LCD display or TFT display). This code, which has been developed in recent years, can code information in two directions and achieves substantially higher densities of information than the traditional bar code.

Although the present invention has been described with reference to specific embodiments, those of skill in the art will recognize that changes may be made thereto without departing from the spirit and scope of the invention as set forth in the hereafter appended claims.

1. A method for performing a cashless payment transaction using a mobile terminal having an image output device and an identifying identifier, a trader station having an image reading device and a central station connected to the trader station via a data network, the method comprising the steps of:
displaying graphically coded output information, via the image output device, suitable for authenticating a user;
reading the graphically coded output information into the trader station by an image reading device;
transforming the graphically coded output information into a digital code; and
authenticating the digital code by the central station.

2. A method for performing a cashless payment transaction as claimed in claim 1, the method further comprising the step of producing the graphically coded output information from at least one of a PIN number, an identification number stored on an SIM card in the mobile terminal, and a telephone number.

3. A method for performing a cashless payment transaction as claimed in claim 1, the method further comprising the steps of:
setting and storing an electronic credit in a credit memory in the central station;
triggering a coding algorithm in an encryption device in the mobile terminal to produce the digital code;
converting the digital code into the graphically coded output information via a conversion device;
using the image reading device to read the graphically coded output information;
transmitting the digital code to the central station together with a sum to be paid;
triggering an inverse coding algorithm in a decryption device in the central station to decrypt the digital code into user information;
comparing the user information with authentication information stored in a user memory; and
triggering a confirmation signal, performing a decimation function for the electronic credit by the sum received via a decimation device, and storing the credit balance in the credit memory if authentication has occurred.

4. A method for performing a cashless payment transaction as claimed in claim 3, wherein a confirmation function is triggered after the decimation function has been performed, and the confirmation function is transmitted to the trader station.

5. A method for performing a cashless payment transaction as claimed in claim 1, wherein the graphically coded output information is displayed on the image output device of the mobile terminal as a bar code, which may be a two-dimensional bar code.

6. A method for performing a cashless payment transaction as claimed in claim 1, wherein the image reading device is a bar code scanner.

7. A method for performing a cashless payment transaction as claimed in claim 1, wherein the graphically coded output information is displayed on the image output device in a stipulated time interval of 2 to 5 seconds.

8. A method for performing a cashless payment transaction as claimed in claim 1, wherein the mobile terminal is a mobile radio terminal.

9. A method for performing a cashless payment transaction as claimed in claim 1, wherein the mobile terminal is a PDA.

10. A method for performing a cashless payment transaction as claimed in claim 1, wherein the graphically coded output information is produced using an asymmetric encryption protocol, which is one of an RSA protocol and an ECC protocol.

11. A mobile terminal for performing a cashless payment transaction, comprising an encryption device for encrypting user information into a digital code, the user information including at least one of a PIN number, an identification number stored on an SIM card in the mobile terminal and a telephone number.

12. A central station for performing a cashless payment transaction, comprising:
a credit memory for storing an electronic credit associated with a user;
a user memory for storing at least one item of authentication information associated with the user, the authentication information including at least one of a PIN number, an identification number stored on an SIM card in the mobile terminal and a telephone number;
a decryption device for decrypting a digital code received from a trader station into user information;
a comparator device for comparing the authentication information stored in the user memory with the user information decrypted by the decryption device, and for triggering a confirmation signal from a confirmation device if authentication has occurred; and
a decimation device for decimating the electronic credit by a sum received from the trader station in response to the confirmation signal.
